(19) United States
(12) Patent Application Publication
(10) Pub. No.: US 2005/0052723 A1
(43) Pub. Date: Mar. 10, 2005

(54) Electrostatic comb drive actuator, and optical controller using the electrostatic comb drive actuator

(76) Inventors: Shin-Ichiro Watanabe, Yokohama-shi (JP); Koji Horio, Yokohama-shi (JP); Kenichi Muta, Yokohama-shi (JP); Masayoshi Esashi, Sendai-shi (JP)

Correspondence Address: TOWNSEND & BANTA, 601 PENNSYLVANIA AVE N.W., SUITE 900, SOUTH BLDG, WASHINGTON, DC, 20004, US

(21) Appl. No.: 10/895,290

(22) Filed: Jul. 21, 2004

(30) Foreign Application Priority Data
Jul. 22, 2003 (JP) 2003-277821

(51) Int. Cl. G02B 26/00

(52) U.S. Cl. 359/290

(57) ABSTRACT

An electrostatic comb drive actuator, characterized in that plural outer suspended elastic beams 2a and 2b are disposed in parallel to and outside plural inner suspended elastic beams 1a and 1b disposed in parallel to each other; the ends of the inner suspended elastic beams and the outer suspended elastic beams on both sides are connected with end connecting beams 3a and 3b; the outer suspended elastic beams are supported at their centers on a board 5; the inner suspended elastic beams are connected with each other at their centers by means of a working section 6; a movable comb electrode 7 is supported on the working section; and a fixed comb electrode 8 is supported on the board.

### FIELD OF THE INVENTION

The present invention relates to an electrostatic comb drive actuator, particularly an electrostatic comb drive actuator using the micro-electro-mechanical system technology, and also to an optical controller using the electrostatic comb drive actuator.

### BACKGROUND OF THE INVENTION

In recent years, owing to the development of the micro-electro-mechanical system (MEMS) technology applying the semiconductor microfabrication technology, micro-electro-mechanical systems are used in various application fields. For example, the application of MEMS to optical technology, i.e., optical MEMS shows a remarkable progress in recent years, and small-sized high-performance high-function optical controllers for performing optical operations by means of mechanical motions are being realized.

For example, U.S. Pat. No. 6,459,845 describes a variable optical attenuator (VOA) in which a shutter or mirror is movably installed between an optical fiber of transmission side and an optical fiber of reception side so that the attenuation of the light transmitted from the transmission side to the reception side can be changed.

The variable optical attenuator has a constitution in which a working section such as a shutter or mirror is driven by means of an electrostatic comb drive actuator, and the working section that is integral with a movable comb electrode is suspended and supported by a spring and returned to its home position by the resiliency of the spring during de-energization.

The suspension and support structure using one spring like this is unstable in the action of the working section, and to prevent it, for example, a structure as shown in FIG. 8, in which a pair of springs disposed in parallel to each other are used for supporting the working section, can be considered.

In FIG. 8, symbol a indicates a working section with a shutter section c capable of intercepting an optical beam b, and the working section a is suspended and supported by a pair of springs d disposed in parallel to each other on the right and left sides in the drawing. The ends e of these springs are immovably supported on a board not shown in the drawing.

Furthermore, the working section a is movably integral with a movable comb electrode not shown in the drawing. A fixed comb electrode that works with the movable comb electrode as a component of an electrostatic comb drive actuator is fixed on the board.

In the above-mentioned suspension and support mechanism as shown in FIG. 8, since the working section is moved in a parallel link mechanism consisting of a pair of springs disposed in parallel to each other on the right and left sides, it can act stably.

However, in this suspension and support structure, since the working section can be moved only to such an extent that the springs can be elastically deformed in the length direction, the moving range, i.e., the stroke of the working section cannot be extended, and in the above-mentioned VOA, the adjustable attenuation range cannot be extended.

An object of this invention is to solve the above-mentioned problem by providing an electrostatic comb drive actuator that can stably move its working section and can have a larger stroke.

Another object of this invention is to provide a small-sized optical controller stable in action, using the electrostatic comb drive actuator solving the above-mentioned problem.

However, the electrostatic comb drive actuator of this invention can be used not only for the optical controller but also for various devices using a small actuator needless to say.

### SUMMARY OF THE INVENTION

To solve the above-mentioned problem, this invention proposes an electrostatic comb drive actuator, characterized in that plural outer suspended elastic beams are disposed in parallel to and outside plural inner suspended elastic beams disposed in parallel to each other; the ends of the inner suspended elastic beams and the outer suspended elastic beams on both sides are connected with end connecting beams; the outer suspended elastic beams are supported at their centers on a board; the inner suspended elastic beams are connected with each other at their centers by means of a working section; a movable comb electrode is supported on the working section; and a fixed comb electrode is supported on the board.

This invention further proposes an electrostatic comb drive actuator int above mentioned constitution, wherein the distance between the inner suspended elastic beam and the outer suspended elastic beam on the side toward which the working section is moved by the energization of the comb electrodes is kept wider than the distance between the inner suspended elastic beam and the outer suspended elastic beam on the other side.

This invention still further proposes an electrostatic comb drive actuator in the above-mentioned constitution, wherein the movable comb electrode is reinforced to have higher flexural rigidity.

This invention still further proposes an electrostatic comb drive actuator in the above-mentioned constitution, wherein the board is provided with a stopper for limiting the movement of the working section by the energization, to such an extent that the movable comb electrode does not contact the fixed comb electrode.

This invention still further proposes an electrostatic comb drive actuator in the above-mentioned constitution, wherein the energization of the fixed comb electrode is made from a wiring pattern formed on the board through the support portion at the center of one of the outer suspended elastic beams; and the wiring pattern is partially held between said support portion and the board for achieving electric connection.

This invention still further proposes in claim 6 an optical controller in which an optical element is provided in the working section of the aforesaid electrostatic comb drive actuator.

This invention still further proposes an electrostatic comb drive actuator in the above-mentioned constitution, wherein the optical element is a shutter.

This invention still further proposes an electrostatic comb drive actuator in the above-mentioned constitution, wherein return light-preventing V-shaped grooves are formed in the shutter.

According to this invention as described above, if the fixed comb electrode and the movable comb electrode of the electrostatic comb drive actuator are energized, the electrostatic attractive force acting between them causes the movable comb electrode to move toward the fixed comb electrode, and the working section is moved together with the movable comb electrode.

In this case, since the working section is supported in a parallel link mechanism by the plural inner suspended elastic beams, it can be moved stably. In this movement, since the ends of the inner suspended elastic beams on both sides apply tensile force to the end connecting beams, the end connecting beams pull the ends of the outer suspended elastic beams on both sides and resiliently deform them as supported by the support portions at their centers. Since the working section can be moved in response to the entire deformation obtained by adding the resilient deformation of the inner suspended elastic beams to that of the outer suspended elastic beams, the moving range of the working section by the electrostatic comb drive actuator can be extended compared with the conventional actuator.

If the energization of the fixed comb electrode and the movable comb electrode is stopped, the working section is returned to its home position together with the movable comb electrode by the resilient return force of the inner suspended elastic beams and the outer suspended elastic beams.

As described above, the electrostatic comb drive actuator of this invention can stably move its working section and can have a larger stroke.

If the distance between the inner suspended elastic beam and the outer suspended elastic beam on the side toward which the working section is moved by the energization of the comb electrodes is kept wider than the distance between the inner suspended elastic beam and the outer suspended elastic beam on the other side, the wasteful space can be minimized.

If the movable comb electrode and the fixed comb electrode are made larger in aspect ratio, longer in the overall length and more narrow in the intervals between the comb teeth for increasing the number of teeth, a larger electrostatic attractive force can be generated. In this case, if the movable comb electrode is reinforced to have higher flexural rigidity, it can be prevented that the electrostatic attractive force bends the movable comb electrode, and as a result, it can be prevented that the movable comb electrode and the fixed comb electrode contact each other.

Furthermore, if the board is provided with a stopper for limiting the movement of the working section by the energization, to such an extent that the movable comb electrode does not contact the fixed comb electrode, the occurrence of any trouble due to the contact between the movable comb electrode and the fixed comb electrode can be prevented.

Moreover, if the energization of the fixed comb electrode is made from a wiring pattern formed on the board through the support portion at the center of one of the outer suspended elastic beams, and the wiring pattern is partially held between said support portion and the board for achieving electric connection, then the wiring work can be made efficient.

If the electrostatic comb drive actuator constituted as described above is used with an optical element provided in the working section, a small-sized high-precision optical controller such as a VOA or optical switch can be constituted.

In the case where the optical element is a shutter, if return light-preventing V-shaped grooves are formed in the shutter as described in claim 8, the adverse effect of return light can be prevented in the optical controller.

### BRIEF DESCRIPTION OF THE DRAWINGS

FIG. 1 is a plan view typically showing a variable optical attenuator comprising the electrostatic comb drive actuator of this invention in its de-energized state

FIG. 2 is a plan view typically showing a variable optical attenuator comprising the electrostatic comb drive actuator of this invention in its energized state

FIG. 3 is a perspective view typically showing a variable optical attenuator comprising the electrostatic comb drive actuator of this invention in its de-energized state

FIG. 4 is a perspective view typically showing a variable optical attenuator comprising the electrostatic comb drive actuator of this invention in its energized state

FIG. 5 is an A-A sectional view of FIG. 1

FIG. 6 is a plan view typically showing the electrostatic comb drive actuator of this invention without the reinforcement for enhancing flexural rigidity in its de-energized state

FIG. 7 is a plan view typically showing the electrostatic comb drive actuator of this invention without the reinforcement for enhancing flexural rigidity in its energized state

FIG. 8 is a plan views showing the suspension and support structure of the conventional electrostatic comb drive actuator in its de-energized state (a) and energized state (b)

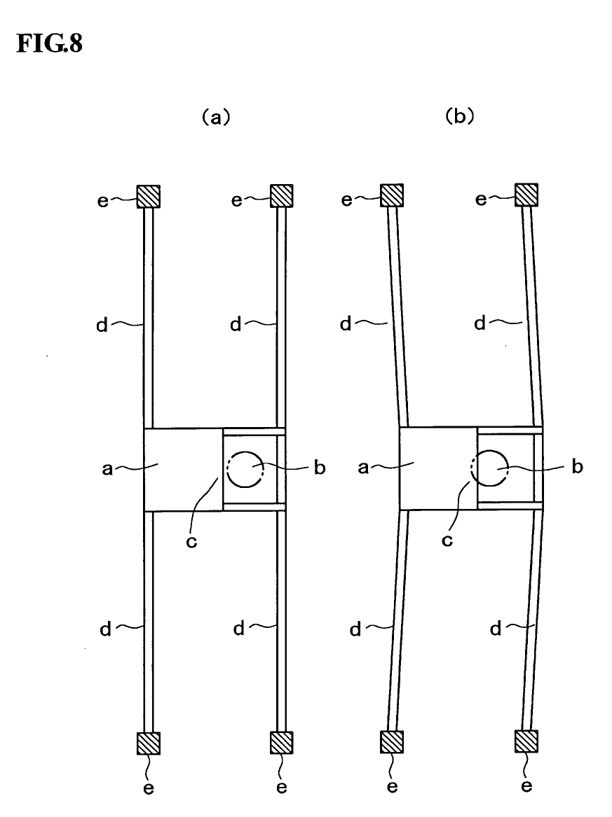

### DETAILED DESCRIPTION OF THE PREFERRED EMBODIMENT

The detail of this invention is described below as an example in reference to the attached drawings.

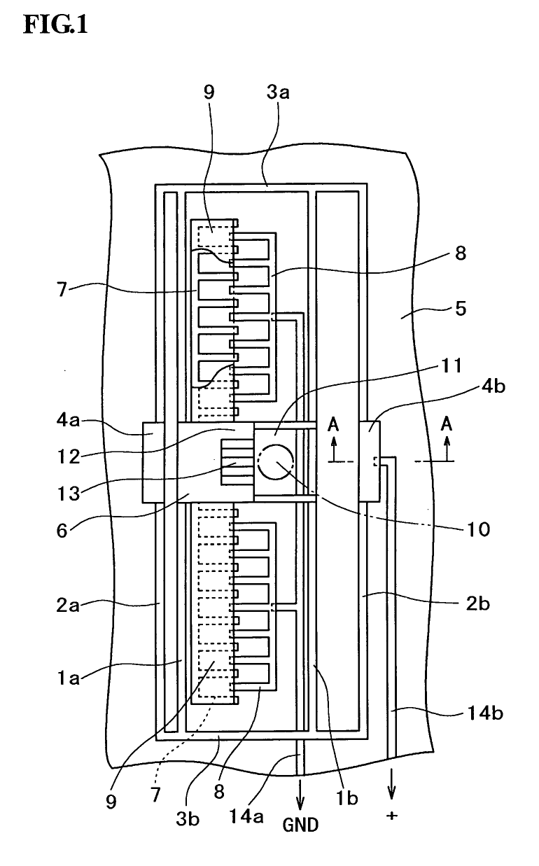

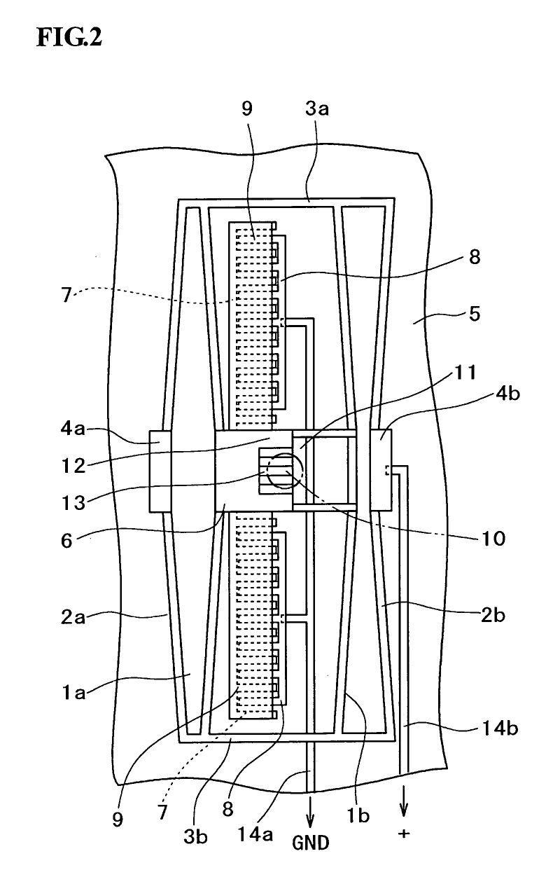

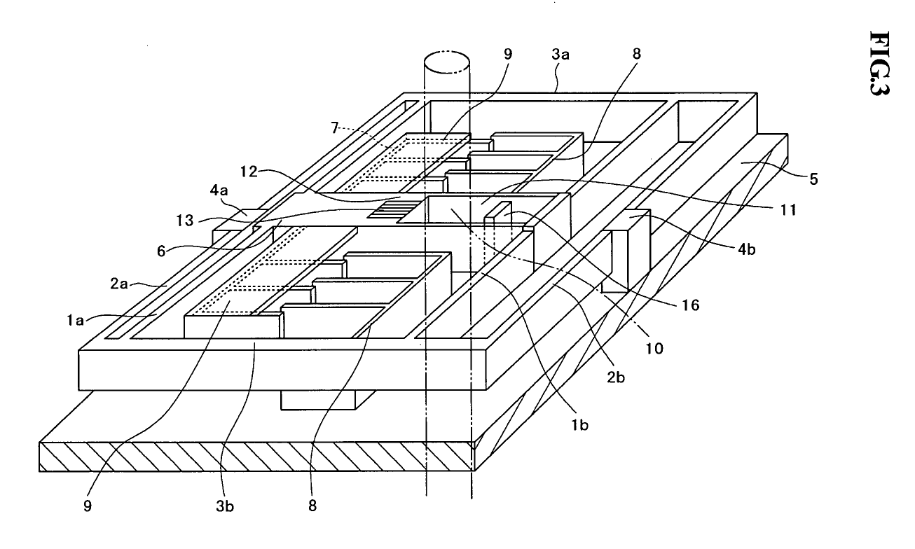

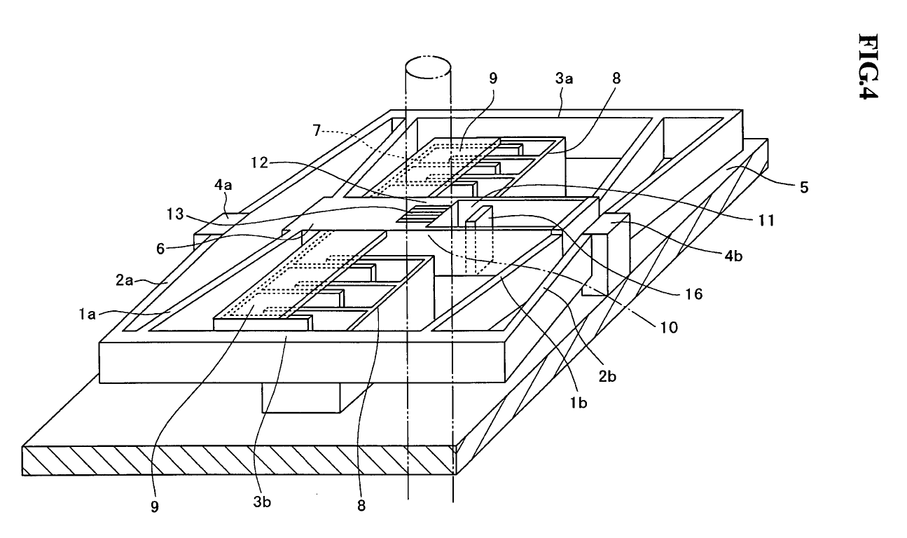

FIGS. 1 and 2 are plan views showing a VOA as an optical controller comprising the electrostatic comb drive actuator of this invention. FIGS. 3 and 4 are perspective views showing the constitution in a simplified and typified manner.

Symbols 1a and 1b denote a plurality of, in this case, a pair of inner suspended elastic beams disposed in parallel to each other, and outside them, outer suspended elastic beams 2a and 2b are disposed in parallel to each other. The ends of the inner suspended elastic beams 1a and 1b and the outer suspended elastic beams 2a and 2b on both sides are connected with end connecting beams 3a and 3b.

The outer suspended elastic beams 2a and 2b are supported at support portions 4a and 4b at their centers on a board 5. Furthermore, the inner suspended elastic beams 1a and 1b are connected with each other at their centers by a working section 6. The working section 6 can be formed as required suitably for each application, and in this example, it is embodied as a shutter provided as an optical element. This constitution is described later.

Under the working section 6, a movable comb electrode 7 is supported, and a fixed comb electrode 8 is supported on the board 5.

The movable comb electrode 7 is formed as a cantilever, and has a large aspect ratio and a long length, so that it can have numerous teeth, while the fixed comb electrode 8 also has numerous teeth. In this constitution, the electrostatic attractive force acting during energization can be made large. In this connection, a roof-like reinforcing plate 9 is integrally formed at the top of the movable comb electrode 7, to enhance the flexural rigidity.

As illustrated, the distance between the inner suspended elastic beam 1b and the outer suspended elastic beam 2b on the side toward which the working section 6 is moved by the energization of the comb electrodes 7 and 8 is kept wider than the distance between the inner suspended elastic beam 1a and the outer suspended elastic beam 2a on the other side.

The working section 6 is embodied as a shutter provided as an optical element as described before, and consists of a transmitting portion 11 for an optical beam 10 indicated by a dot-dash-line in the drawings and a shutter portion 12, and the shutter portion 12 has return light-preventing V-shaped grooves 13 for preventing the return reflection of the optical beam 10.

The above-mentioned components can be made of silicon on the board 5 such as borosilicate glass by applying the MEMS technology.

The return light-preventing V-shaped grooves 13 can be formed, for example, using an Au/Cr film.

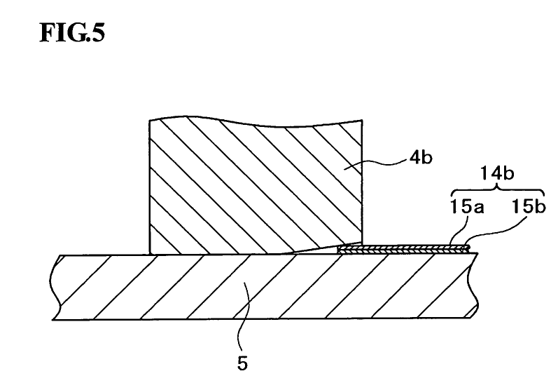

In the drawings, symbol 14a indicates a wiring pattern formed on the board 5 for energizing the fixed comb electrode 8, and symbol 14b indicates the wiring pattern formed on the board for energizing the movable comb electrode 7. The movable comb electrode 7 is energized from this wiring pattern 14b through the support portion 4b at the center of the outer suspended elastic beam 2b. In this constitution, electric connection is achieved by holding a part of the wiring pattern 14b between the support portion 4b and the board 5 as shown in FIG. 5. This connection structure can also be applied to the fixed comb electrode 8 and the wiring pattern 14a, and allows efficient working work.

As shown in FIG. 5, each of the wiring patterns 14a and 14b can be, for example, a double layer consisting of a Pt layer 15a and a Ti layer 15b, or can have any other structure as required.

As shown in FIGS. 3 and 4, the board 5 is provided with a stopper 16 for limiting the movement of the working section 6 by the energization, hence the movement of the movable comb electrode 7, lest the movable comb electrode 7 should contact the fixed comb electrode 8.

In the above-mentioned constitution, when the fixed comb electrode 8 and the movable comb electrode 7 are not energized, the working section 6 and the movable comb electrode 7 are kept in their stationary positions shown in FIG. 1 or FIG. 3 by the return resiliency of the inner suspended elastic beams 1a and 1b and the outer suspended elastic beams 2a and 2b, and in this state, the shutter 12 does not intercept the optical beam 10 at all.

If the fixed comb electrode 8 and the movable comb electrode 7 are energized through the wiring patterns 14b and 14a, an electrostatic attractive force acts between them, and as shown in FIG. 2 or 4, the movable comb electrode 7 is moved toward the fixed comb electrode 8, i.e., rightward in FIGS. 1 and 2, and the working section 6 is moved together with the movable comb electrode 7.

In this case, since the working section 6 is supported in a parallel link mechanism by the pair of inner suspended elastic beams 1a and 1b, it can be stably moved.

In this movement, since the ends of the inner suspended elastic beams 1a and 1b on both sides apply a tensile force to the end connecting beams 3a and 3b, the end connecting beams 3a and 3b pull both the ends of the outer suspended elastic beams 2a and 2b. So, the outer suspended elastic beams are resiliently deformed, while being supported by the support portions 4a and 4b at their centers.

Thus, since the working section 6 can be moved in response to the entire deformation obtained by adding the resilient deformation of the outer suspended elastic beams 2a and 2b to the resilient deformation of the inner suspended elastic beams 1a and 1b, the movable range of the working section 6 by the electrostatic comb drive actuator can be greatly extended.

If the energization of the fixed comb electrode 8 and the movable comb electrode 7 is stopped, the working section 6 can be returned to the original stationary position together with the movable comb electrode 7 by the resilient return force of the inner suspended elastic beams 1a and 1b and the outer suspended elastic beams 2a and 2b.

In this case, the electrostatic attractive force acting between the fixed comb electrode 8 and the movable comb electrode 7 is proportional to the square of the voltage applied to them. So, if the applied voltage is adjusted, the working section 6 can be kept at a position at which the electrostatic attractive force balances said resilient return force. In this way, the rate of intercepting the optical beam 10 by the shutter portion 12 can be adjusted to change the attenuation.

In this example, the working section 6 is constituted such that the rate of intercepting the optical beam 10 by the shutter portion 12, hence the light attenuation becomes larger when the applied voltage is higher, but on the contrary, the working section can also be constituted such that the light attenuation becomes smaller when the applied voltage is higher.

The electrostatic comb drive actuator of this invention can keep the action of the working section 6 stable and can have a larger stroke.

As illustrated, since the distance between the inner suspended elastic beam 1b and the outer suspended elastic beam 2b on the side toward which the working section 6 is moved by the energization of the comb electrodes 7 and 8 is kept wider than the distance between the inner suspended elastic beam 1a and the outer suspended elastic beam 2a on the other side, the wasteful space on said other side can be minimized.

As described above, the movable comb electrode 7 and the fixed comb electrode 8 have a large aspect ratio and a longer overall length, with the intervals between their teeth narrowed to increase the number of teeth. So, a large electrostatic attractive force can be generated.

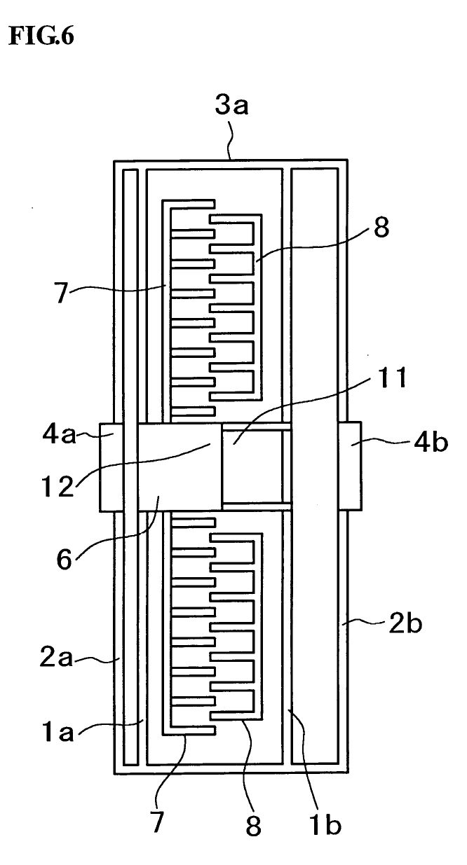

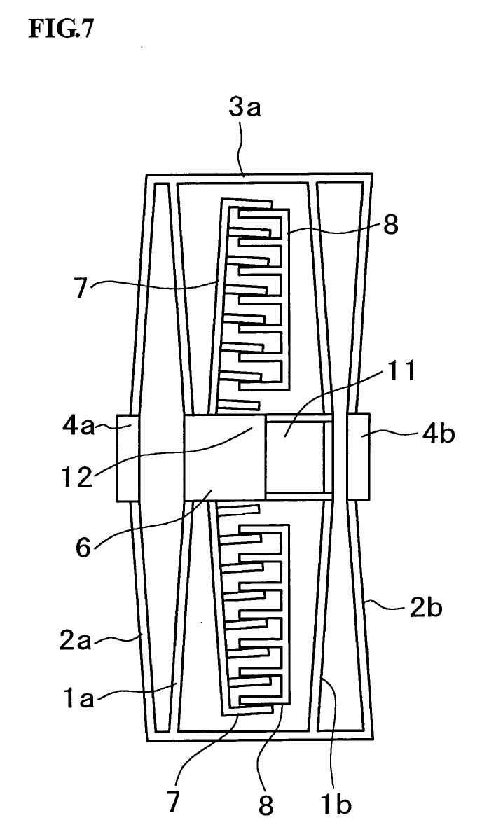

FIGS. 6 and 7 show the action in the case where the flexural rigidity of the movable comb electrode 7 is not sufficient. In this case, if a large electrostatic attractive force is generated by the energization, the movable comb electrode 7 is bent as shown in FIG. 7, and there occurs such a trouble that the comb teeth of the movable comb electrode 7 and those of the fixed comb electrode 8 contact each other.

Therefore, if, as shown in FIG. 2, the movable comb electrode 7 is provided with a roof-like reinforcing plate 9 or the like, to have high flexural rigidity, it can be prevented that the movable comb electrode 7 is bent by an electrostatic attractive force, hence it can be prevented that the comb teeth of the movable comb electrode 7 and those of the fixed comb electrode 8 contact each other.

On the other hand, in the case where the voltage applied between the movable comb electrode 7 and the fixed comb electrode 8 is likely to be too high, if the board 5 is provided with the stopper 16 as shown in FIGS. 3 and 4, the occurrence of the trouble that the movable comb electrode 7 and the fixed comb electrode 8 contact each other can be prevented even if an excessively high voltage is applied.

### Industrial Applicability

As described above, this invention can provide an electrostatic comb drive actuator that can stably move its working section, can have a larger stroke, and is very small-sized under the application of the MEMS technology.

The electrostatic comb drive actuator can be used not only for a VOA described in the above example, but also for the following devices.

a. An optical switch installed at an angle of 45 degrees in reference to the optical axis for reflecting light on the surface of its shutter in an ON/OFF manner.

b. An optical switch for directly driving an optical fiber

c. A wavelength variable filter, variable resonator or the like having an optical element fixed in its working section

d. Various sensors for acceleration, angular velocity, vibration, pressure and the like based on the measurement of electrostatic capacity

e. Sensors for examining the presence or absence of an object using DNA chips, μTSA, etc.

f. A passage opening/closing device comprising a shutter as its working section, for opening and closing a passage.

1. An electrostatic comb drive actuator, characterized in that plural outer suspended elastic beams are disposed in parallel to and outside plural inner suspended elastic beams disposed in parallel to each other; the ends of the inner suspended elastic beams and the outer suspended elastic beams on both sides are connected with end connecting beams; the outer suspended elastic beams are supported at their centers on a board; the inner suspended elastic beams are connected with each other at their centers by means of a working section; a movable comb electrode is supported on the working section; and a fixed comb electrode is supported on the board.

2. An electrostatic comb drive actuator, according to claim 1, wherein the distance between the inner suspended elastic beam and the outer suspended elastic beam on the side toward which the working section is moved by the energization of the comb electrodes is kept wider than the distance between the inner suspended elastic beam and the outer suspended elastic beam on the other side.

3. An electrostatic comb drive actuator, according to claim 1, wherein the movable comb electrode is reinforced to have higher flexural rigidity.

4. An electrostatic comb drive actuator, according to claim 1, wherein the board is provided with a stopper for limiting the movement of the working section by the energization, to such an extent that the movable comb electrode does not contact the fixed comb electrode.

5. An electrostatic comb drive actuator, according to claim 1, wherein the energization of the fixed comb electrode is made from a wiring pattern formed on the board through the support portion at the center of one of the outer suspended elastic beams; and the wiring pattern is partially held between said support portion and the board for achieving electric connection.

6. An optical controller using an electrostatic comb drive actuator, characterized in that an optical element is provided in the working section of the electrostatic comb drive actuator as set forth in claim 1.

7. An optical controller using an electrostatic comb drive actuator, according to claim 6, wherein the optical element is a shutter.

8. An optical controller using an electrostatic comb drive actuator, according to claim 7, wherein return light-preventing V-shaped grooves are formed in the shutter.
